(19) United States
(12) Patent Application Publication
(10) Pub. No.: US 2007/0234803 A1
(43) Pub. Date: Oct. 11, 2007

(54) Yaw Rate Sensor

(76) Inventors: Udo-Martin Gomez, Leonberg (DE); Reinhard Neul, Stuttgart (DE); Kersten Kehr, Zwota (DE); Marko Rocznik, Sindelfingen (DE)

Correspondence Address: KENYON & KENYON LLP, ONE BROADWAY, NEW YORK, NY, 10004, US

(21) Appl. No.: 10/577,743

(22) PCT Filed: Aug. 13, 2004
(86) PCT No.: PCT/DE04/01809

§ 371 Date: Feb. 13, 2007

(30) Foreign Application Priority Data
Oct. 27, 2003 (DE) 10350037.5

(51) Int. Cl. G01C 19/56

(52) U.S. Cl. 73/504.12

(57) ABSTRACT

The yaw rate sensor of the present invention has force-conveying means. The central idea of the invention is that the force action conveyed by this arrangement has a frequency such that the frequency of the conveyed force action is an integral multiple of the frequency of the oscillation of the drive element parallel to the X-axis.

### FIELD OF THE INVENTION

The present invention is directed to a yaw rate sensor.

### BACKGROUND INFORMATION

The yaw rate sensor according to prepublished application German Published Patent Application No. 102 37 411 is a linearly oscillating vibration gyroscope having quadrature compensation structures. The distinguishing feature of this type of yaw rate sensor is that two substructures are driven parallel to the substrate surface. It is driven in such a way that the directions of movement of the substructures are diametrically opposite. Both substructures are mechanically joined together by a coupling spring. In the ideal case, only the forces caused by the Coriolis acceleration in the direction of detection would effectively act on the Coriolis element of such a quadrature compensated yaw rate sensor. The detection direction is understood to be the direction of movement orthogonal to the direction of movement of the particular drive frame and lying in the plane of the substrate. Due to non-linearities of the coupling springs, however, the Coriolis element is induced to an undesired oscillation which is in phase with the oscillation of the drive frame and possesses double the frequency. This oscillation represents an interfering signal which is subsequently referred to as a 2f signal. For the analysis of the measuring signal of force-compensated yaw rate sensors, the 2f signal signifies a limitation in the design of the force feedback because the 2f signal is greater than the Coriolis acceleration-induced measuring signal to be analyzed. It is therefore necessary to suppress or to compensate the 2f signal.

### SUMMARY OF THE INVENTION

The present invention is directed to a yaw rate sensor. Provided are a yaw rate sensor having a substrate, a drive element, and a Coriolis element which is situated above a surface of a substrate. Coriolis element (2a, 2b) may be induced by the drive element to oscillate parallel to an X-axis. In this connection, it is possible to detect a deflection of the Coriolis element provided in a Y-axis which is essentially perpendicular to the X-axis. The X-and Y-axes are parallel to the surface of the substrate. The yaw rate sensor according the present invention has force-conveying means to convey a dynamic force action between the substrate and the Coriolis element. The central idea of the invention is that the force action conveyed by these means has at least one frequency such that the frequency of the conveyed force action is an integral multiple of the frequency of the oscillation of the drive element parallel to the X-axis. A yaw rate sensor of this type may be used to compensate an interfering signal having a frequency which is an integral multiple of the frequency of the drive oscillation. Such an interfering signal is, for example, the 2f signal.

In a first embodiment of the present invention, the force-conveying means are provided in such a way that they indirectly convey the dynamic force action between the substrate and the Coriolis element. This is done in such a way that a direct force action is conveyed between the substrate and a detection element. Additional electrodes on the detection element are used for this purpose. The detection element is coupled to the Coriolis element by springs in such a way that the desired dynamic force action is ultimately conveyed between the substrate and the Coriolis element.

In a particularly advantageous embodiment of the present invention, the force-conveying means are provided in such a way that they directly convey the dynamic force action between the substrate and the Coriolis element. This is advantageous in compensating the 2f signal because this signal arises directly at the Coriolis element during oscillations. The direct dynamic force action between the substrate and the Coriolis element makes it possible to compensate the 2f signal at its origin. The existing quadrature compensation structures are used in this connection as force-conveying means. It is thus not necessary to provide additional structures for 2f signal compensation.

It is advantageous that detection means are provided on the drive element via which the position of the drive element parallel to the X-axis is detected. This makes it possible to detect the exact phase position of the drive oscillation. It is further advantageous that the conveyed force action has a fixed phase relationship to the oscillation of the drive element parallel to the X-axis and that the phase of the conveyed force action may be set parallel to the X-axis in relation to the oscillation of the drive element. This makes it possible to achieve the best possible compensation of the 2f signal.

In another advantageous embodiment of the invention, the force-conveying means are provided in such a way that the amplitude of the force action is also determined in the Y-axis from the deflection of the detection element. This is achieved by a control that ensures that it is possible to compensate the 2f signal even if it changes over time. It is thus possible to compensate the interfering signal using the suitable amplitude in both rapid and slow changes, e.g., in the event of material change or material fatigue over the life of the yaw rate sensor.

Another advantageous embodiment of the present invention provides two Coriolis elements positioned symmetrically in relation to one another, one in particular mechanically designed coupling being provided between the Coriolis elements. The positioning of the Coriolis elements is advantageous for the actual function of the yaw rate sensor. This is a particularly advantageous embodiment of the present invention. The coupling is provided by a coupling spring in particular. This coupling spring has a non-linearity which results in particular in an interfering signal having double the frequency of the drive oscillation, i.e., the 2f signal. The yaw rate sensor according to the present invention is able to compensate this 2f signal.

It is particularly advantageous that the frequency of the conveyed force action is generated by an electromechanical multiplication of the frequency of the oscillation of the drive element out of phase with itself. This is the case, for example, when the force action is conveyed directly between the substrate and the Coriolis element by the quadrature compensation structures. Due to the fact that the result acts directly on the Coriolis element, the signal evaluation circuit may be designed to be substantially more sensitive irrespective of the 2f signal. As a result of this type of signal multiplication, the multiplicand is depicted in a mechanical form by quadrature electrode overlapping and the multiplier is depicted in electrical form by the applied voltage of the multiplication. It is advantageous that no additional electrodes are provided for conveying the force action. The 2f signal is directly compensated at its origin, and one of two signals necessary for this purpose and uninfluenced by electrical noise is used directly in the mechanism for compensating the 2f signal. The 2f signal is causally compensated before it becomes relevant for the electronics for analyzing the yaw rate detected by the yaw rate sensor. It is further advantageous in particular that the frequency of the conveyed force action amounts to double the frequency of the oscillation of the drive element. The conveyed force action is thus suitable, in particular for compensating the 2f signal.

### BRIEF DESCRIPTION OF THE DRAWINGS

FIG. 1 shows a micromechanical yaw rate sensor having quadrature compensation structures according to the related art.

FIG. 2 schematically shows the yaw rate sensor according to the present invention having dynamic 2f signal suppression using additional electrodes and electronic circuitry.

FIG. 3 schematically shows a yaw rate sensor according to the present invention having dynamic 2f signal suppression by electromechanical multiplication with fixed 2f compensation voltage.

FIG. 4 schematically shows another yaw rate sensor according to the present invention having dynamic 2f signal suppression by electromechanical multiplication with regulated 2f compensation voltage.

FIG. 5 schematically shows another yaw rate sensor according to the present invention having dynamic 2f signal suppression by electromechanical multiplication with regulated 2f compensation voltage and regulated quadrature compensation voltage.

### DETAILED DESCRIPTION

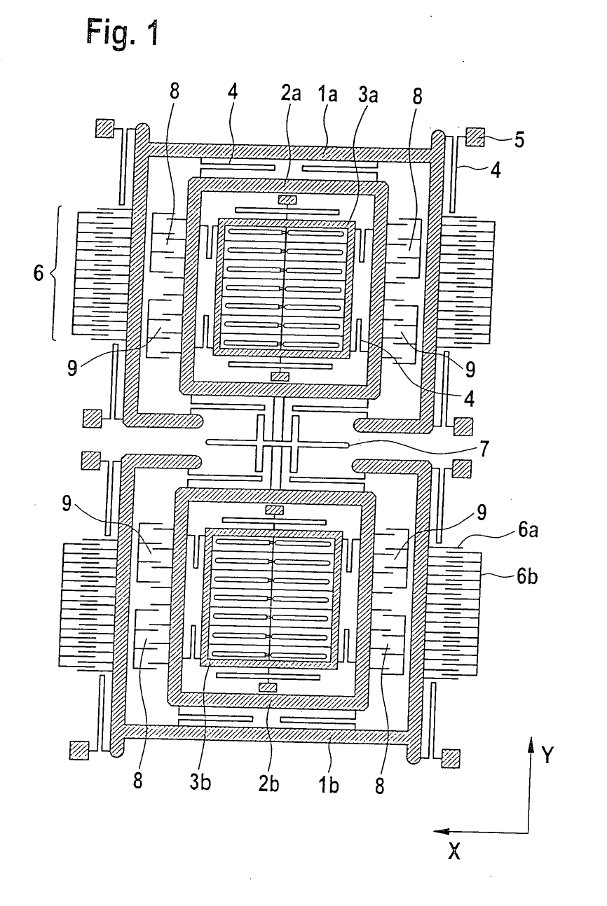

The invention is elucidated in detail with reference to the embodiments described below. FIG. 1 shows a micromechanical yaw rate sensor having quadrature compensation structures according to the related art, as described in application German Published Patent Application No. 102 37 411. The micromechanical yaw rate sensor is made up of a plurality of subelements, namely drive element 1a, 1b, Coriolis element 2a, 2b, and detection element 3a, 3b. Each of the three elements includes 2 subelements having mirror symmetry. In the embodiment shown here, drive element 1a, 1b is designed as an open frame. It is connected via U-shaped springs 4 to anchoring points 5, which are in turn fixedly connected to the substrate. Located within drive element 1a, 1b is Coriolis element 2a, 2b, which in this case forms a closed frame. Coriolis element 2a, 2b is connected to drive element 1a, 1b by U-shaped springs 4. Located within Coriolis element 2a, 2b is detection element 3a, 3b, which is also designed as a closed frame and is attached to the detection means. Detection element 3a, 3b is also connected to Coriolis element 2a, 2b by U-shaped springs 4. Comb drives 6 are situated at two diametrically opposed sides of drive element 1a, 1b in such a way that drive element 1a, 1b is able to induce oscillations parallel to a first axis X. Comb drive 6 is a capacitor system, a force action being evoked by applying a voltage between its electrodes 6a, 6b. First electrode 6a is rigidly connected to drive element 1a, 1b. Second electrode 6b is rigidly connected to the substrate. The two parts of Coriolis element 2a and 2b are connected to one another by coupling springs 7. The system shown mechanically couples the oscillation of drive element 1a, 1b and of Coriolis element 2a, 2b of the two substructures in such a way that oscillation characteristics of advantage for the analysis of the yaw rate signal are made possible. Quadrature compensation structures 8, 9 as described in German Published Patent Application No. 102 37 411 are situated on Coriolis element 2a, 2b. Quadrature compensation structures 8, 9 may be situated on subelements 2a, 2b in different ways. FIG. 1 shows only one embodiment. Structures 8, 9 are plate capacitor systems that are essentially able to exert a force action parallel to a second axis Y.

Quadrature compensation structures 8, 9 reduce the quadrature signal which is caused by manufacturing-related imperfections in the micromechanical structure. These electrodes make it possible to exert a force action on the Coriolis element by applying a direct voltage, the force action being periodically in phase with the movement of the drive frame. This makes it possible to dynamically compensate the quadrature forces caused by the imperfections.

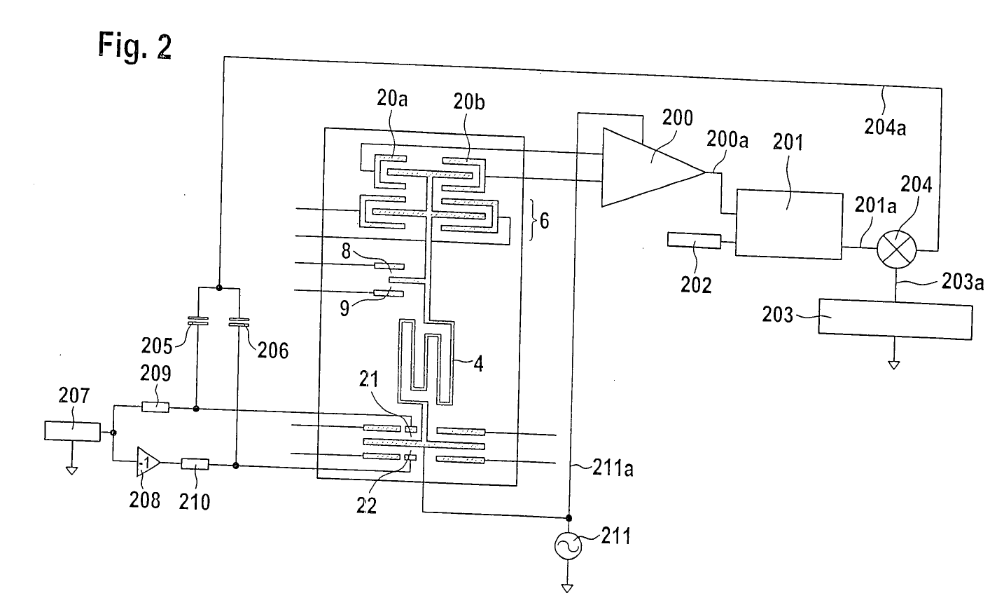

FIG. 2 schematically shows an embodiment of a yaw rate sensor according to the present invention having dynamic 2f signal suppression using additional electrodes and electronic circuitry. Comb drive 6 of the drive element and quadrature compensation structures 8, 9 of the Coriolis element are shown. Also provided are detection means 20a, 20b which are designed to detect the deflection of the drive element parallel to axis X and convert it into a signal. Detection means 20a, 20b may be, for example, plate pairs 20a, 20b of a capacitor structure. Also provided are electrode pairs 21, 22 which are designed in the manner of plate capacitors and are able to exert electrostatic forces on the detection element parallel to second axis Y. The detection element is coupled to the Coriolis element by springs 4. Thus, the actions of forces are conveyed indirectly between the substrate and Coriolis element. For compensating the 2f signal, a signal having a suitable phase is applied to electrode pairs 21, 22 whose frequency is twice as high as the oscillation frequency of drive element 1a, 1b. To that end, the deflection of drive element 1a, 1b is first determined at detection means 20a, 20b and converted into a voltage signal 200a, the drive oscillation signal, in an evaluation circuit 200 using a high-frequency signal 211 a generated by a frequency generator 211. Voltage signal 200a, which has the frequency of the drive element oscillation, is fed to a phase locked loop (PLL) 201. Phase locked loops are known circuit configurations whose output signal is in a fixed and adjustable ratio to the input signal and whose output frequency is a multiple of the frequency of the input. Phase relationship 202 of output signal 201a is set directly in the PLL between the phase comparator and the loop filter. Signal 201a has double the frequency of signal 200a and is fed to an input of multiplier 204, i.e., an amplifier having regulable amplification. A 2f oscillation compensation voltage 203a is present at the other input of multiplier 204. Voltage 203a originates from a direct voltage source and is fixedly set in such a way that the 2f signal is compensated as completely as possible. 2f compensation signal 204a is provided at the output of multiplier 204. Signal 204a is divided into two signal paths and is fed to electrode pairs 21, 22 via an electronic circuit made up, for example, of capacitors 205, 206, direct voltage source 207, inverter 208 and resistors 209, 210. Electrode pairs 21, 22 convey a force action having double the frequency of the oscillation of the drive element. The phase relationship of this periodic force action to the drive oscillation is set using phase adjuster 202 in such a way that the 2f signal is compensated.

An additional electrode pair is necessary for the yaw rate sensor having the type of compensation of the 2f signal described above. An existing electrode pair divided in the time multiplex or in another manner may be used as an alternative. However, the PLL and the time multiplex circuit are expensive with respect to circuitry. Therefore, yaw rate sensors of the present invention which are less expensive with respect to circuitry and require no additional electrode pair are described below.

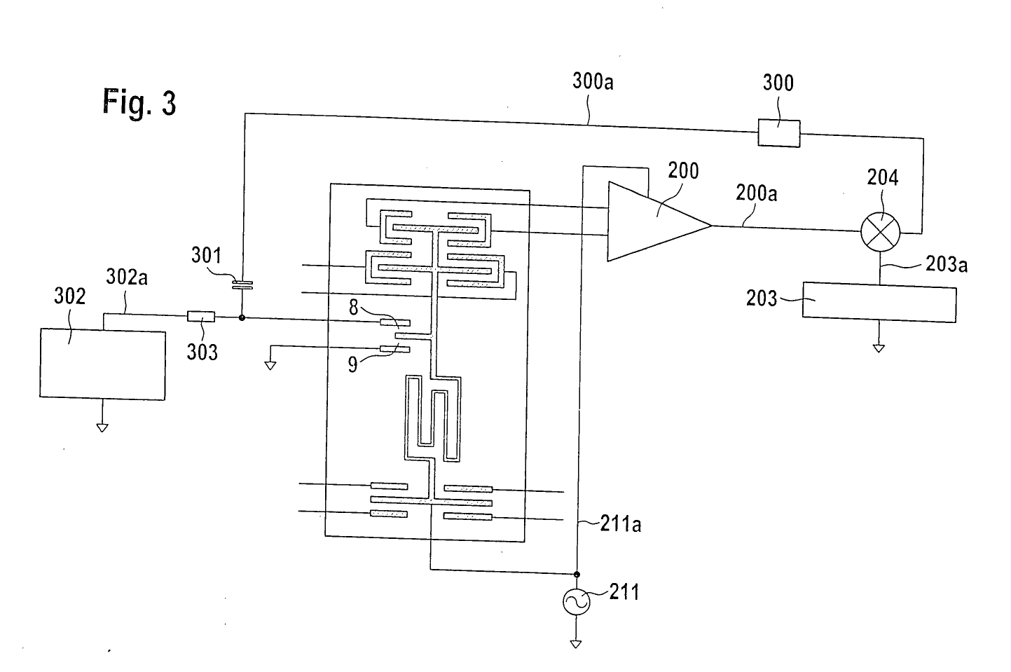

FIG. 3 schematically shows an embodiment of a yaw rate sensor according to the present invention having dynamic 2f signal suppression at a fixed 2f compensation voltage. In this embodiment, the force action for the 2f signal compensation is conveyed directly between the substrate and the Coriolis element by quadrature compensation structures 8, 9. Voltage signal 200a having the frequency of the drive voltage is fed in this case directly to multiplier 204. As described in FIG. 2, 2f oscillation compensation voltage 203a is present at the other input of multiplier 204. The output of multiplier 204 is connected to the input of a phase correction circuit 300. At the output of this circuit 300, a signal 300a having the frequency of the drive oscillation as well as a suitable phase and amplitude, i.e., 2f compensation signal 300a, is provided for suppressing the 2f signal. Signal 300a is fed to quadrature compensation structures 8, 9 via a capacitor 301. Likewise, quadrature compensation voltage 302a is fed from direct voltage source 302 to quadrature compensation structures 8, 9 via a resistor 303. The yaw rate sensor of the present invention shown in FIG. 3 provides for the use of quadrature compensation structures 8, 9 for conveying forces to the Coriolis element. The original use of quadrature compensation structures 8, 9 provides for the application of a direct voltage 302a, which causes a force action on the Coriolis element which is changeable over time due to the overlapping of quadrature electrodes 8, 9 which is changeable over time. This embodiment of the present invention, using the described circuit configuration, provides for an alternating voltage 300a whose frequency corresponds to that of the drive frame oscillation to be added to this direct voltage 302a in suitable form. A phase shifting circuit 300, such as an all-pass or a digital time-delay element, is provided to set a suitable phase position of compensation signal 300a in relation to drive oscillation signal 200a, which is suitable for causing the 2f signal compensation. As in the case of the circuit configuration shown in FIG. 2, the size of the required 2f signal compensation is set by direct voltage 203a.

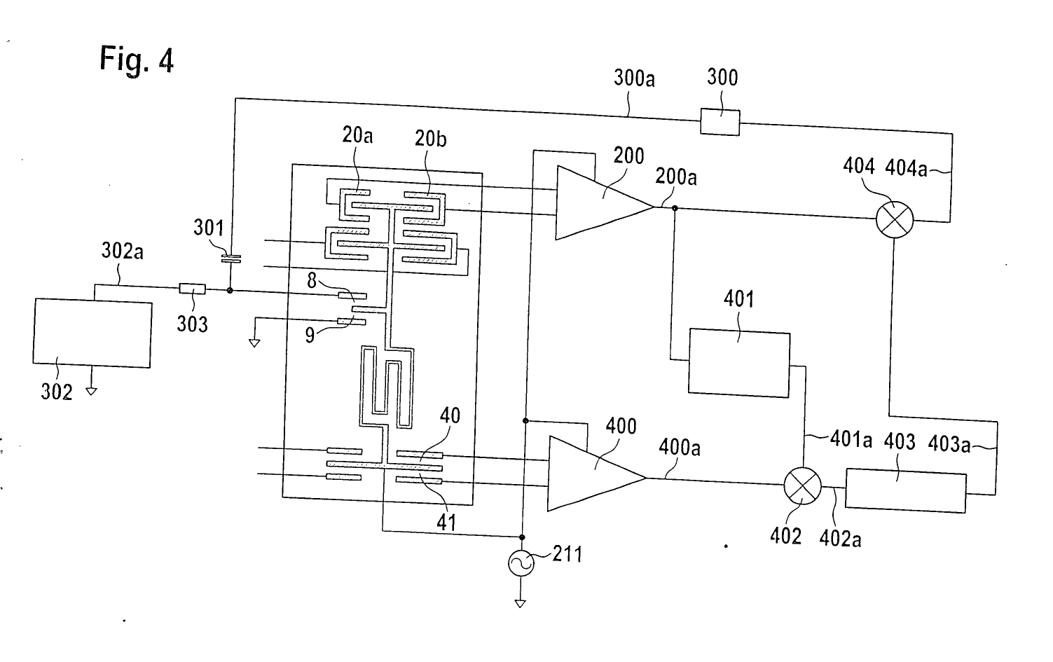

FIG. 4 schematically shows a yaw rate sensor having dynamic 2f signal suppression in another embodiment of the present invention. In contrast to the preceding embodiment according to FIG. 3, the amplitude of the 2f compensation signal is now regulated. The yaw rate sensor has detection means 40, 41 which may be, for example, electrode pairs in the form of a plate capacitor. The deflection of the detection element in a direction parallel to axis Y is first determined at detection means 40, 41, and it is converted into a voltage signal 400a, i.e., detection oscillation signal 400a, in an evaluation circuit 200, using high-frequency signal 211 a generated by a frequency generator 211. Drive oscillator signal 200a is fed to a phase locked loop 401. A signal 401 a having twice the frequency of drive oscillator signal 200a is provided at the output of phase locked loop 401. Signal 401a and detection oscillator signal 400a are present at the inputs of a multiplier 402. This circuit synchronously demodulates detection oscillator signal 400a at double the frequency of drive oscillator signal 200a. Demodulated signal 402a at the output of multiplier 402 is fed to a proportional-integral differential regulator (PID regulator), which provides signal 403a at its output. This PID regulator is designed in such a way that the exact voltage required to compensate the 2f signal is always set. The further signal path and the operating mode correspond to the embodiment shown in FIG. 3.

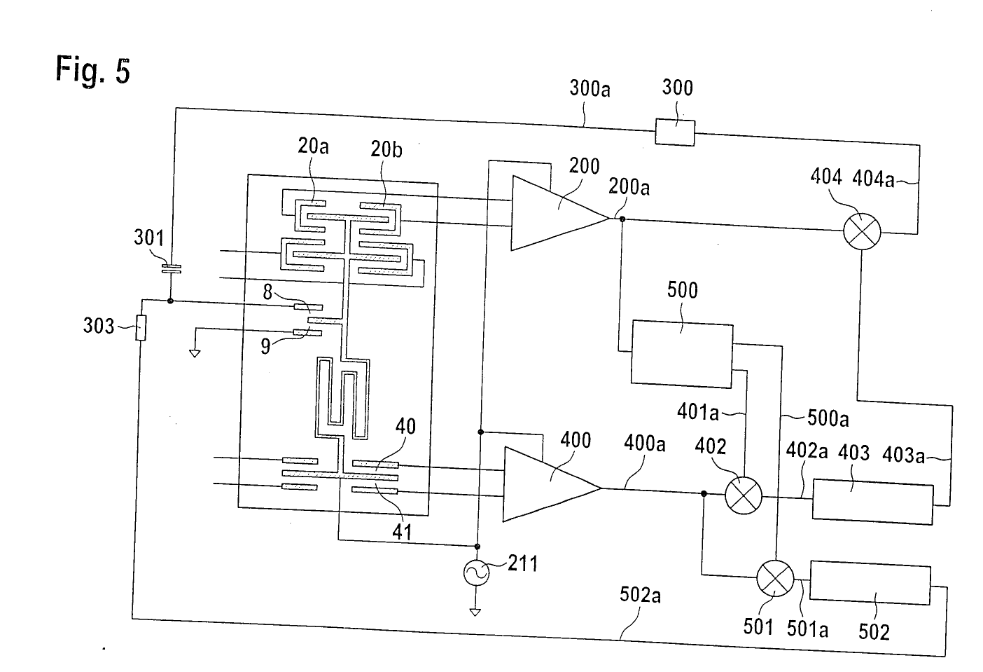

FIG. 5 schematically shows a yaw rate sensor having dynamic 2f signal suppression in another embodiment of the present invention. The embodiment shown in FIG. 5 corresponds to the embodiment shown in FIG. 4, but it additionally provides for quadrature compensation regulation. To that end, drive oscillator signal 200a is first fed to a phase locked loop 500. A signal 500a having the frequency of drive oscillator signal 200a is provided at the output of phase locked loop 500. Signal 500a and detection oscillator signal 400a are present at the inputs of a multiplier 501. This circuit synchronously demodulates detection oscillator signal 400a at the frequency of drive oscillator signal 200a. Demodulated signal 501a at the output of multiplier 501 is fed to a PID regulator 502, which provides signal 502a at its output. This PID regulator 502 is designed in such a way that the exact direct voltage 502 required to compensate the quadrature signal is always set. Analogous to the depiction in FIG. 3, this regulated voltage 502a is fed to quadrature compensation structures 8, 9 instead of fixed direct voltage 302a. The further signal path and the operating mode correspond to the embodiment shown in FIG. 4.

In the case of the embodiments of the yaw rate sensor shown in FIGS. 3, 4 and 5, care must be taken in designing the circuitry that the direct voltage present at quadrature compensation structures 8, 9 is greater than the amplitude of the 2f compensation signal. Should this not be the case, this must be accomplished as in FIG. 2 by applying a corresponding direct voltage at the diametrically opposed electrode and performing a quadrature compensation adapted thereto.

1.-10. (canceled)

11. A yaw rate sensor, comprising:
a substrate;
a drive element;
a Coriolis element situated above a surface of the substrate; and
a force-conveying arrangement for conveying a dynamic action of a force between the substrate and the Coriolis element, wherein:
the Coriolis element is capable of being induced by the drive element to oscillate parallel to a first axis,
a deflection of the Coriolis element in a second axis that is substantially perpendicular to the first axis is detectable,
the first axis and the second axis are parallel to the surface of the substrate, and
the force action has at least one frequency such that is an integral multiple of a frequency of oscillation of the drive element parallel to the first axis.

12. The yaw rate sensor as recited in claim 11, wherein the force-conveying arrangement directly conveys the dynamic action between the substrate and the Coriolis element.

13. The yaw rate sensor as recited in claim 11, further comprising:
a plurality of springs; and
a detection element coupled to the Coriolis element via the springs, wherein:
the force-conveying arrangement indirectly conveys the dynamic action between the substrate and the Coriolis element in such a manner that a direct force action is conveyed between the substrate and the detection element, and
the detection element is coupled to the Coriolis element by the springs in such a way that the dynamic action is conveyed between the substrate and the Coriolis element.

14. The yaw rate sensor as recited in claim 11, further comprising:
a detection arrangement via which a position of the drive element parallel to the first axis is detected.

15. The yaw rate sensor as recited in claim 11, wherein the dynamic action has a fixed phase relationship to the oscillation of the drive element parallel to the first axis.

16. The yaw rate sensor as recited in claim 1 1, wherein a phase of the dynamic action conveyed by the force-conveying arrangement is adjustable in relation to the oscillation of the drive element parallel to the first axis.

17. The yaw rate sensor as recited in claim 14, wherein the force-conveying arrangement is provided in such a way that an amplitude of the dynamic action is determined by a deflection of the detection arrangement in the second axis.

18. A yaw rate sensor, comprising:
a substrate;
a drive element;
two Coriolis elements situated above a surface of the substrate and positioned symmetrically with respect to one another;
a mechanical coupling provided between the two Coriolis elements; and
a force-conveying arrangement for conveying a dynamic action of a force between the substrate and the Coriolis element, wherein:
the Coriolis elements are capable of being induced by the drive element to oscillate parallel to a first axis,
a deflection of the Coriolis elements in a second axis that is substantially perpendicular to the first axis is detectable,
the first axis and the second axis are parallel to the surface of the substrate, and
the force action has at least one frequency such that is an integral multiple of a frequency of oscillation of the drive element parallel to the first axis.

19. The yaw rate sensor as recited in claim 11, wherein:
a frequency of the conveyed dynamic action is a product of an electromechanical multiplication, the multiplicand including a signal having the frequency of the oscillation of the drive element, and a multiplier including a signal having the frequency of the oscillation of the drive element with a phase shift to a multiplicand.

20. The yaw rate sensor as recited in claim 11, wherein a frequency of the conveyed dynamic action equals two times the frequency of the oscillation of the drive element.
